(19) United States
(12) Patent Application Publication
(10) Pub. No.: US 2014/0205266 A1
(43) Pub. Date: Jul. 24, 2014

(54) Method, Apparatus and Computer Program Product for Summarizing Media Content

(71) Applicants: Rohit Atri, Bangalore (IN); Sidharth Patil, Bangalore (IN); Aditya Bheemarao, Bangalore (IN); Sujay Patil, Bangalore (IN); Subodh Sachan, Bangalore (IN)

(72) Inventors: Rohit Atri, Bangalore (IN); Sidharth Patil, Bangalore (IN); Aditya Bheemarao, Bangalore (IN); Sujay Patil, Bangalore (IN); Subodh Sachan, Bangalore (IN)

(73) Assignee: NOKIA CORPORATION, Espoo (FI)

(21) Appl. No.: 13/983,200

(22) PCT Filed: Jan. 19, 2012
(86) PCT No.: PCT/FI2012/050043

§ 371 Date: Oct. 10, 2013

(30) Foreign Application Priority Data
Feb. 18, 2011 (IN) 464/CHE/2011

(51) Int. Cl. H04N 5/93

(52) U.S. Cl. CPC H04N 5/93
USPC 386/248

(57) ABSTRACT

In accordance with an example embodiment a method and apparatus is provided. The method comprises facilitating receiving of a preference information associated with a media content comprising a set of frames. A score is assigned to at least one frame of the set of frames by at least one filter. The score is assigned based on the preference information and a weight associated with the at least one filter. A rank is determined for the at least one frame based on the score.

### TECHNICAL FIELD

Various implementations relate generally to method, apparatus, and computer program product for summarizing media content in electronic devices.

### BACKGROUND

The rapid advancement in technology related to capture and display of media content has resulted in an exponential growth of expanding media content collection. Devices like mobile phones and personal digital assistants (PDA) are now being increasingly configured with video capture tools, such as a camera, thereby facilitating easy capture and storage of a large amount of media content, and provide an immediate access to the same whenever required.

The media content, for example videos, in a raw form consists of an unstructured video stream having a sequence of video shots. Each video shot is composed of a number of media frames such that the content of the video shot can be represented by key-frames only. Such key frames containing thumbnails, images, and the like, from the video shot and may be extracted from the video shot to summarize the same. The collection of the key frames associated with a video is defined as video summarization. In general, key frames can act as the representative frames of the video shot for video indexing, surfing, and recovery.

### SUMMARY OF SOME EMBODIMENTS

Various aspects of examples embodiments are set out in the claims.

In a first aspect, there is provided a method comprising: facilitating receiving of a preference information associated with a media content, the media content comprising a set of frames; assigning a score to at least one frame of the set of frames by at least one filter, the score being assigned based on the preference information and a weight associated with the at least one filter; and determining a rank of the at least one frame based on the score.

In a second aspect, there is provided an apparatus comprising: at least one processor; and at least one memory comprising computer program code, the at least one memory and the computer program code configured to, with the at least one processor, cause the apparatus at least to perform: facilitating receiving of a preference information associated with a media content, the media content comprising a set of frames; assigning a score to at least one frame of the set of frames by at least one filter, the score being assigned based on the preference information and a weight associated with the at least one filter; and determining a rank of the at least one frame based on the score.

In a third aspect, there is provided a computer program product comprising at least one computer-readable storage medium, the computer-readable storage medium comprising a set of instructions, which, when executed by one or more processors, cause an apparatus to at least perform: facilitating receiving of a preference information associated with a media content, the media content comprising a set of frames; assigning a score to at least one frame of the set of frames by at least one filter, the score being assigned based on the preference information and a weight associated with the at least one filter; and determining a rank of the at least one frame based on the score.

In a fourth aspect, there is provided an apparatus comprising: means for facilitating receiving of a preference information associated with a media content, the media content comprising a set of frames; means for assigning a score to at least one frame of the set of frames by at least one filter, the score being assigned based on the preference information and a weight associated with the at least one filter; and means for determining a rank of the at least one frame based on the score.

In a fifth aspect, there is provided a computer program comprising program instructions which when executed by an apparatus, cause the apparatus to: facilitate receiving of a preference information associated with a media content, the media content comprising a set of frames; assign a score to at least one frame of the set of frames by at least one filter, the score being assigned based on the preference information and a weight associated with the at least one filter; and determine a rank of the at least one frame based on the score.

### BRIEF DESCRIPTION OF THE FIGURES

The embodiments of the invention are illustrated by way of example, and not by way of limitation, in the figures of the accompanying drawings in which:

FIG. 1 illustrates a device in accordance with an example embodiment;

FIG. 2 illustrates an apparatus for summarizing media content in accordance with an example embodiment;

FIG. 3 is a modular layout for a device for summarizing media content in accordance with an example embodiment; and

FIG. 4 is a flowchart depicting an example method for summarizing media content in accordance with an example embodiment.

### DETAILED DESCRIPTION

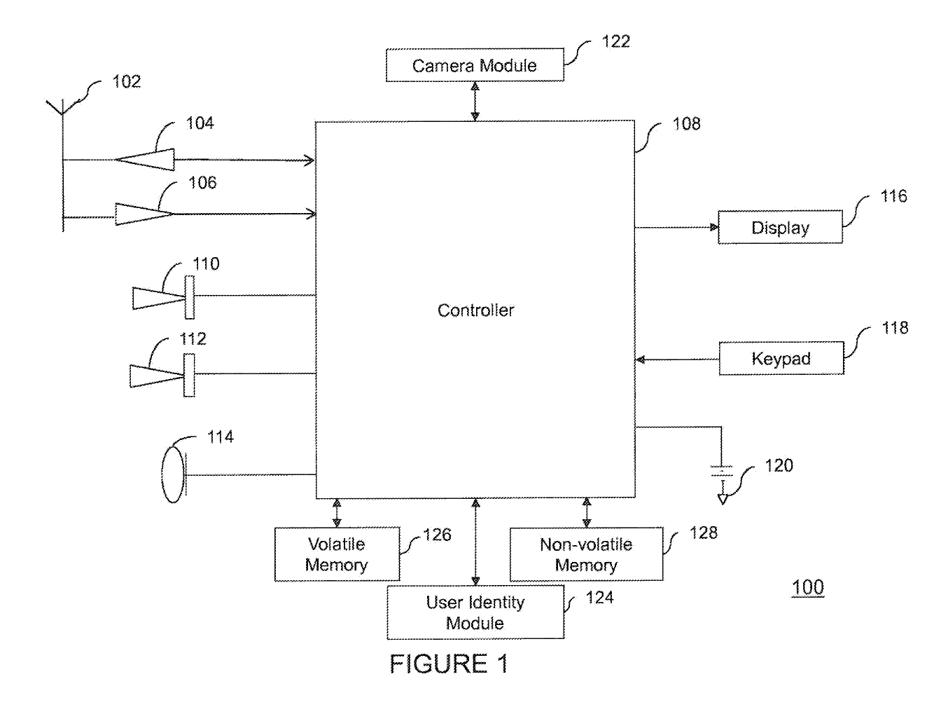

Example embodiments and their potential effects are understood by referring to FIGS. 1 through 4 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2 G) wireless communication protocols IS-136 (time division multiple access (TDMA)), GSM (global system for mobile communication), and IS-95 (code division multiple access (CDMA)), or with third-generation (3 G) wireless communication protocols, such as Universal Mobile Telecommunications System (UMTS), CDMA1000, wideband CDMA (WCDMA) and time division-synchronous CDMA (TD-SCDMA), with 3.9 G wireless communication protocol such as evolved-universal terrestrial radio access network (E-UTRAN), with fourth-generation (4 G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

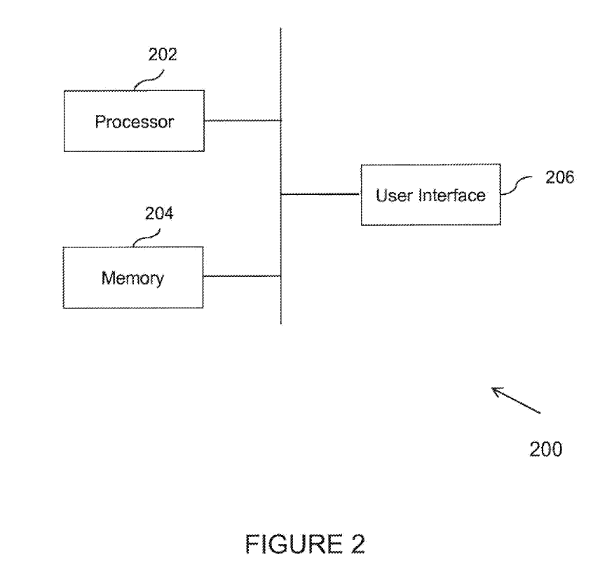

FIG. 2 illustrates an apparatus 200 for summarizing media content in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device includes communication device, media playing device with communication capabilities, computing devices, and the like. Some examples of the communication device may include a mobile phone, a PDA, and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. The media content may include audio content and video content.

In an example embodiment, the processor 202 is configured to, with the content of the memory 204, and optionally with other components described herein, to cause the apparatus 200 to summarize the media content, for example, the video content. The media content may include a set of frames. In an example embodiment, the media content may include a video stream having a set of video frames.

In an example embodiment, the processor 202 is configured to, with the content of the memory 204, and optionally with other components described herein, to cause the apparatus 200 to facilitate receiving of a preference information associated with the media content. In an example embodiment, the preference information may include a plurality of preference attributes and a weight associated with each of the plurality of preference attributes. The preference attributes for a media content, for example, a video of a football game may include a favorite player's moves, highlights of the game, scenes in which the goals/points are made, and the like. Similarly, the preference attributes for a video of a birthday party may include the guests, the birthday cake, the birthday person, and the like. The weight associated with the each of the preference attribute may be positive or negative depending upon the user preference. For example, based on user preference, the user may assign a positive weight to a particular preference attribute (thereby affirming a ‘liking’ for said preference attribute), or a negative weight to another particular preference attribute (thereby affirming a ‘dislike’ for said preference attribute). In an example embodiment, the preference information may be provided by the user. In another example embodiment, the preference information may be provided without the user intervention. For example, the preference information may be provided based on a usage pattern of the user. In an example embodiment, a processing means may be configured to facilitate provisioning of the preference information associated with a media content. An example of the processing means may include the processor 202, which may be an example of the controller 108.

In an example embodiment, a score is assigned to at least one frame of the set of frames by at least one filter. In an example embodiment, the score may be assigned based on the preference information and a weight associated with the at least one filter. In an example embodiment, the at least one filter may include a face recognition filter, a user marked thumbnail (or a poster frame filter), a brightness filter, a color filter, a smile detection filter, a blink detection filter, and the like. A user marked thumbnail filter (or a poster frame filter) enables the user to the pause video-playback and mark the current frame being displayed on screen as a poster frame. The poster frame or a user marked thumbnail refers to a thumbnail in a video that is marked by a user, for example, a video frame chosen by the user to be considered as a thumbnail.

In an example embodiment, the at least one filter is selected based on the preference information pertaining to a media content such as a video. For example, the video may be pertaining to a birthday party of a girl. The preference information may include preferences such as ‘I LIKE the birthday girl’, ‘I DO NOT like the birthday girl's father’, ‘I LIKE the birthday cake’, and the like. In such a case, the at least one filer may include two face recognition filters, F1 (for recognizing the face of the birthday girl) and F2 (for recognizing the face of the birthday girl's father), and one object recognition filter F3 (for recognizing the birthday cake).

In an example embodiment, each of the at least one filter is associated with a weight. In an example embodiment, the weights associated with the at least one filter may be positive or negative depending on the preference information. In an example embodiment, the weights associated with the at least one filter may be predetermined. In another example embodiment, the weights associated with the at least one filter may be determined based on the importance of the at least one filter with reference to the video as set by the preference information. For example, corresponding to a set of preference attributes such as U1, U2, U3 . . . Un, the weights W1, W2, W3 . . . Wn respectively may be assigned.

In an example embodiment, corresponding to every preference attribute, a unique filter may be selected. For example, corresponding to the preference attributes U1 and U3, only the filters F1 and F3 may be selected for processing the frames. In an example embodiment, the weights such as W1, W2, . . . Wn may be user-defined. In an example embodiment, a processing means may be configured to select the at least one filter based on the preference information. An example of the processing means may include the processor 202, which may be an example of the controller 108.

In an example embodiment, the score assigned to the at least one frame may be a consolidated score comprising the score assigned to the at least one frame by each of the selected at least one filter. In an example embodiment, the at least one frame includes a media frame retrieved from a raw video stream. In another example embodiment, the at least one frame is a key frame retrieved from a summarized video stream. In an example embodiment, a processing means may be configured to assign the score to at least one frame by the at least one filter. An example of the processing means may include the processor 202, which may be an example of the controller 108.

In an example embodiment, the processor 202 is configured to, with the content of the memory 204, and optionally with other components described herein, to cause the apparatus 200 to determine a unique rank for each of the at least one frame based on a consolidated score thereof. In an example embodiment, the apparatus 200 may include a ranking module for assigning a rank to each of the frames. In an example embodiment, the ranking may be determined in a static mode, wherein the rank may be determined for each of the frames when the score is assigned to all of the at least one frame by the at least one filter. In another embodiment, the rank may be determined in a dynamic mode, wherein the ranking may be determined immediately after the score is assigned to each of the at least one frame. In an example embodiment, the ranking may be relative to the ranks of the previously processed frames. In an example embodiment, a processing means may be configured to determine a rank of each of the at least one frame based on the scores assigned to said frame. An example of the processing means may include the processor 202, which may be an example of the controller 108.

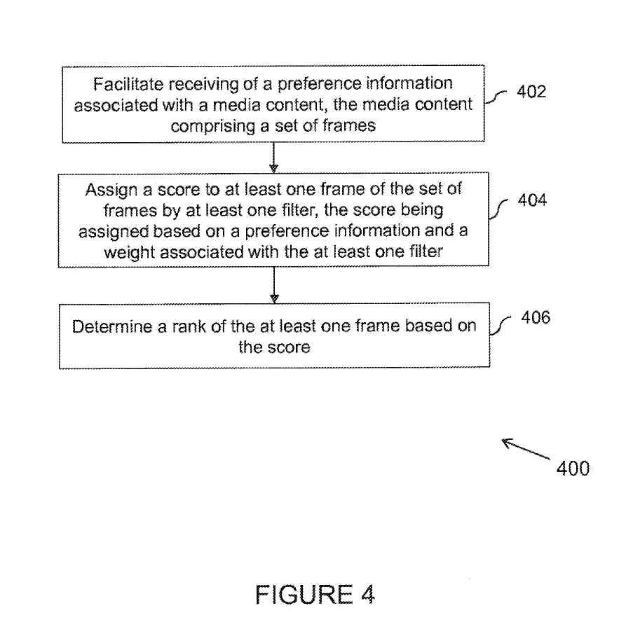

In an example embodiment, the processor 202 is configured to, with the content of the memory 204, and optionally with other components described herein, to cause the apparatus 200 to present the at least one frame based on the ranking. In an example embodiment, presenting the at least one frame includes facilitating displaying the at least one frame based on the rank. For example, the frames having a higher rank may be displayed first while the frames having a lower rank may be displayed later in the order of appearance of the frames in the summarized video. In an example embodiment, the unaltered frame may be provided as an output along with the consolidated score and the rank, and may be utilized for the summarization of the media content. The process of summarization of the media content based on the ranking is explained in FIG. 4.

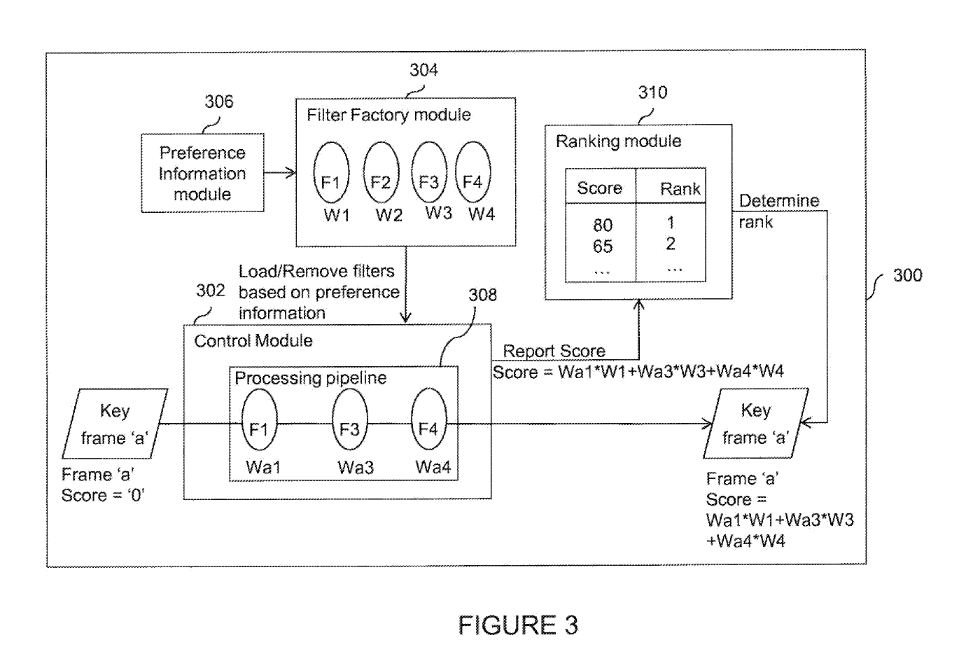

FIG. 3 is a modular layout for a device, for example a device 300 for summarizing media content. The device 300 is broken down into modules and components representing the functional aspects of the device 300. These functions may be performed by the various combinations of software and/or hardware components discussed below.

The device 300 may include a control module, for example a control module 302 for regulating the operations of the device 300. In an example embodiment, the control module 302 may be embodied in form of a controller such as the controller 108 or a processor such as the processor 202. The control module 302 may control various functionalities of the device 300 as described herein. For example, inputs may be received from various other modules included within the device 300, and the control module 302 may interpret these inputs and in response, may issue control commands to the other modules in the device 300.

In an example embodiment, the device 300 includes a filter factory module 304 having a plurality of filters, such as filters F1, F2, F3, F4, and the like. Examples of the plurality of filters include, but are not limited to face recognition filter, user marked thumbnail (or poster frame filter), brightness filter, color filter, smile detection filter, and blink detection filter. In an example embodiment, the plurality of filters may include additional filters. For example, additional filter associated with object recognition may be added to the plurality of filters. Each of the filters such as the filters F1, F2, F3, F4 is associated with a weight such as a weight W1, W2, W3, W4 respectively, as illustrated in FIG. 3. In an example embodiment, the filter factory module 304 may be an example of the processing means. An example of the processing means may include the processor 202, which may be an example of the controller 108.

In an example embodiment, the device 300 includes a preference information module 306 for storing the preferences information pertaining to the media content. The information storing module 306 may be an example of the memory, for example the memory 128. In an example embodiment, the preference information module 306 may store the preference information in the form of a user preference table. In an example embodiment, the user preferences may be received from the user by a user interface, such as the UI 206, or by any other means.

In an example embodiment, the device 300 may include a processing pipeline 308 embodied in the control module 302. The processing pipeline 308 may be configured to receive the plurality of frames such as a frame ‘a’ as input, and based on the user preference, select the at least one filter relevant for the processing of the plurality of frames. For example, the processing pipeline 308 may determine the filters F1, F3 and F4 to be relevant based on the user preference. In an example embodiment, the plurality of frames may be passed through the processing pipeline 308, as illustrated in FIG. 3, and the processing pipeline 308 may determine the score assigned to each frame based on the weight associated with the selected at least one filter. In an example embodiment, the processing pipeline 308 may determine the score based on the equation:

$$Wi = ( {\sum }_{j = 1} Wij * Wj )$$

where, i=a, b, c (i denotes the frames), and
   Wᵢⱼ is the weight assigned to the frame i by the filter j

As illustrated in FIG. 3, when the filters F1, F3 and F4 are selected, the consolidated score may be determined for the frame ‘a’ as: Score=(Wa1*W1+Wa3*W3+Wa4*W4). In an example embodiment, the processing pipeline 308 may report the calculated score to a ranking module 310.

The ranking module 310 is configured to determine a rank of each of the at least one frame based on the score of the at least one frame. In an example embodiment, the rank may be determined in a static mode, wherein the rank is determined for each of the at least one frames when the score are assigned to all the frames. In another embodiment, the rank may be determined in a dynamic mode, wherein the rank may be determined immediately after determining the score of each frame. In an example embodiment, the determined rank may be relative to the rank determined for the previously processed frames. The unaltered frames, for example the frame ‘a’ may be provided as output along with its consolidated score and the ranking, and may be utilized for summarizing the media content.

The control module 302, the filter factory module 304, the preference information module 306, and the ranking module 310, may be implemented as a hardware module, a software module, a firmware module or any combination thereof. In an example embodiment, the control module 302 may facilitate execution of instructions received by the device 300, and a battery unit for providing requisite power supply to the device 300. The device 300 may also include requisite electrical connections for communicably coupling the various modules of the device 300. A method for summarizing media content is explained in FIG. 4.

FIG. 4 is a flowchart depicting an example method 400 for summarizing media content in accordance with an example embodiment. The method 400 depicted in flow chart may be executed by, for example, the apparatus 200 of FIG. 2. Examples of the apparatus 200 include, but are not limited to, mobile phones, personal digital assistants (PDAs), laptops, and any equivalent devices.

Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 400 are described with help of apparatus 200. However, the operations of the method 400 can be described and/or practiced by using any other apparatus.

The method 400 describes steps for summarizing media content, for example, the video content. The media content may include a set of frames. In an example embodiment, the media content may include a video stream having a set of video frames. In an example embodiment, the media content may be a raw video stream. In this embodiment, the set of frames may refer to frames of the raw video stream that has not yet been summarized. In another example embodiment, the media content may refer to a summarized media stream. In this example embodiment, the set of frames comprises key frames of the media content.

At block 402, receiving of a preference information associated with the media content is facilitated. In an example embodiment, the preference information may include the information pertaining to the user preferences. In an example embodiment, the preference information includes a plurality of preference attributes and a weight associated with each of the plurality of preference attributes. For example, for a set of preference attributes such as U1, U2, U3 . . . Un, the corresponding weights may be W1, W2, W3 . . . Wn, respectively. In an example embodiment, the preference information may be stored in form of a user preference table. In an example embodiment, the preferences attributes may be received from the user by means of a user interface, such as the UI 206, or by any other means. The user preference information may be utilized for selecting at least one filter for each of the at least one frame. For example, the filters such as the face recognition filter and the object recognition filter may match with the preference attributes provided by the user, and may be selected.

At block 404, a score is assigned to at least one frame of the set of frames by the at least one filter. In an example embodiment, the score may be assigned based on the preference information and a weight associated with the at least one filter. In an example embodiment, the at least one filter may be contained in a filter factory, as described in FIG. 3. The at least one filter may include filters such as face recognition filter, user marked thumbnail (or poster frame filter), brightness filter, color filter, smile detection filter, and blink detection filter. In an example embodiment, additional filters may be added to the plurality of filters. For example, upon development of a new or improved algorithm for object recognition, an improved object recognition filter may be added to the at least one filter.

In an example embodiment, each of the user preference attributes is associated with a weight (Wⱼ). In an example embodiment, the weight Wⱼ may be positive or negative based on the user preference. For example, a preference such as “I LIKE property X” may be translated to a filter with weight Wₓ being a positive quantity, while a preference “I DO NOT LIKE property Y” may be translated to a filter with weight W_{y} being a negative quantity. In an example embodiment, the weight corresponding to the at least one filter may be calculated based on the importance of the at least one filter as determined by the user or user preference information. In another example embodiment, the default weight may be assigned to the at least one filter. In an example embodiment, corresponding to every preference attribute, a unique filter may be selected. For example, corresponding to the preference attributes U1 and U3, only the filters F1 and F3 may be selected for processing the frames. In an example embodiment, the weights such as W1, W2, . . . Wn may be user-defined.

In an example embodiment, the score may be assigned to each of the at least one frame by the at least one filter based on the preference attributes and the weight associated with the at least one filter. Also, a consolidated score of each of the at least one frame may be determined. In an example embodiment, the initial default scores may be set to be zero. In an example embodiment, the score for the at least one frame may be calculated as:

$$Wi = ( {\sum }_{j = 1} Wij * Wj )$$

where, i=a, b, c (i denotes the frames), and
   Wᵢⱼ is the weight assigned to the frame i by the filter j.

At block 406, a ranking may be determined for each of the at least one frame based on the scores assigned thereto. In an example embodiment, the rank may be determined in a static mode, wherein the rank may be determined for each of the at least one frame when all the frames are processed. In another embodiment, the rank may be determined in a dynamic mode, wherein the rank may be determined immediately after each frame of the at least one frame is processed. In an example embodiment, the rank may be relative to the ranks of the previously processed frames.

In an example embodiment, the plurality of frames may be presented as an output based on the ranking. In an example embodiment, each of the at least one frame may be presented along with a consolidated score and the ranking, that may be utilized for summarizing the media content. In an example embodiment, presenting the at least one frame includes facilitating displaying the at least one frame in order of ranking. The at least one frame may be displayed in order of ranking in the summarized video.

In an example embodiment, a processing means may be configured to perform some or all of: facilitating receiving of a preference information associated with a media content, the media content comprising a set of frames; assigning a score to at least one frame of the set of frames by at least one filter, the score being assigned based on the preference information and a weight associated with the at least one filter; and determining a rank of the at least one frame based on the score. An example of the processing means may include the processor 202, which may be an example of the controller 108.

It will be understood that although the method 400 of FIG. 4 shows a particular order, the order need not be limited to the order shown, and more or fewer blocks may be executed, without providing substantial change to the scope of the present disclosure.

An example illustrating the method of summarizing the media content is described, wherein the media content includes a video of a ‘birthday party’. The frames from the video may be received as an input to the apparatus, such as the apparatus 200. In an example embodiment, the at least one frame includes a media frame retrieved from a raw video stream. In another example embodiment, the at least one frame includes a key frame retrieved from a summarized video stream.

In an example embodiment, the user preference attributes may be received by means of the UI for example the UI 206. The user preference attribute table may include the following example preferences attributes:
I LIKE the face of Birthday girl (+) (Weight=+100)
I LIKE the birthday cake (+) (Weight=+60)
I LIKE the face of the girl's father (+) (Weight=+40)
I LIKE the face of the girl's mother (+) (Weight=+40)
I DO NOT LIKE the face of girl's grandfather (−) (Weight=−100)

As indicated by the ‘+’ sign in braces, the first four preferences are positive in nature, while the ‘−’ sign indicates that the last preference is negative in nature. Hence, the weights of the respective at least one filter may be positive or negative depending upon the preference attributes. In the present example, the weights assigned to the at least one filter are considered to be positive unity and negative unity, however, in other examples, the values of weights may include numeric positive and negative values other than unity.

Based on the said preference attributes, four face recognition filters and one object recognition filter may be loaded by the filter factory to the processing pipeline as below:
Face Recognition Filter F1 (candidate face=girl's face); (weight=100)
Face Recognition Filter F2 (candidate face=girl's face mother's); (weight=40)
Face Recognition Filter F3 (candidate face=girl's father's face); (weight=40)
Face Recognition Filter F4 (candidate face=girl's grandfather's face); (weight=−100)
Object Recognition Filter F5 (candidate object=cake); (weight=60)

Every frame passing through the processing pipeline may be assigned a score by each of the five filters F1, F2, F3, F4 and F5. For example, the four candidate frames may contain the following:
Frame 1 may contains a birthday girl, frame 2 may contain birthday girl and the cake, frame 3 may contain birthday girl and her parents, and frame 4 may contain birthday girl's grandparents. The score assigned for these frames may be as follows:
For frame 1, the score=100
For frame 2, the score=100+60=160
For frame 3, the score=100+2*40=180
For frame 4, the score=−100

In an example embodiment, the scores of the respective frames may be tabulated by the ranking module as:
Rank 1 for the frame 3 having a highest score of +180 points
Rank 2 for the frame 2 having the score of +160 points
Rank 3 for the frame 1 having the score of +100 points
Rank 4 for the frame 4 having the score of −100 points

In an example embodiment, the media content, i.e. the frames associated with the video of the birthday party may be presented based on the ranking. For example, the frame may be displayed in order of ranking thereof in a summarized video of the birthday party.

Without in any way limiting the scope, interpretation, or application of the claims appearing below, a technical effect of one or more of the example embodiments disclosed herein is to summarize media content based on ranking of the frames. The frames may be retrieved from a summarized media content, and ranked based on preference attribute information. The preference attribute information may include user preference pertaining to the content of the media content, and may be provided by the user. The ranking based summarization of the media content provides personalized, distinctive and customizable solution to different users having distinctive requirements. A personalized solution is created, in a way, in which videos are summarized and then frames or scenes are presented to the user. The method enables video summarization methods to generate frames, which are more relevant to the user and ordered according to his/her preferences. The dynamic ranking mechanism for ranking various frames provides an improved see-n-seek video experience for the user by facilitating the user to see the most preferred scenes always in the beginning, thereby reducing the number of clicks to be performed for acquiring the preferred content, and the time required to get the same. The ranking of the frames is applicable to video players across a set of electronic devices such as hand held communication devices, camera, and any other device including the video players.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-34. (canceled)

35. A method comprising:
facilitating receiving of a preference information associated with a media content comprising a set of frames;
assigning a score to at least one frame of the set of frames by at least one filter based on the preference information and a weight associated with the at least one filter; and
determining a rank of the at least one frame based on the score.

36. The method as claimed in claim 35, wherein the preference information comprises a plurality of preference attributes and a weight associated with the plurality of preference attributes.

37. The method as claimed in claim 36, wherein the weight associated with the plurality of preference attributes is user-defined.

38. The method as claimed in claim 35, wherein the at least one frame comprises a media frame retrieved from a raw video stream.

39. The method as claimed in claim 35, wherein each of the at least one frame comprises a key frame retrieved from a summarized video stream.

40. The method as claimed in claim 35, wherein the plurality of filters comprises face recognition filter, user marked thumbnail filter, brightness filter, color filter, smile detection filter, or blink detection filter.

41. The method as claimed in claim 35 further comprising presenting the at least one frame based on the rank.

42. The method as claimed in claim 41, wherein presenting comprises facilitating displaying the at least one frame based on the rank.

43. An apparatus comprising:
at least one processor; and
at least one memory comprising computer program code, the at least one memory and the computer program code configured to, with the at least one processor, cause the apparatus at least to perform:
facilitate receiving of a preference information associated with a media content comprising a set of frames;
assign a score to at least one frame of the set of frames by at least one filter based on the preference information and a weight associated with the at least one filter; and
determine a rank of the at least one frame based on the score.

44. The apparatus as claimed in claim 43, wherein the preference information comprises a plurality of preference attributes and a weight associated with the plurality of preference attributes.

45. The apparatus as claimed in claim 44, wherein the weight associated with the preference attributes is user-defined.

46. The apparatus as claimed in claim 43, wherein the at least one frame comprises a media frame retrieved from a raw video stream.

47. The apparatus as claimed in claim 43, wherein each of the at least one frame comprises a key frame retrieved from a summarized video stream.

48. The apparatus as claimed in claim 43, wherein the plurality of filters comprises face recognition filter, user marked thumbnail filter, brightness filter, color filter, smile detection filter, or blink detection filter.

49. The apparatus as claimed in claim 43, wherein the apparatus is further caused, at least in part, to perform: present the at least one frame based on the rank.

50. The apparatus as claimed in claim 49, wherein the apparatus is further caused, at least in part, to perform: facilitate display of the at least one frame based on the rank.

51. A computer program comprising at least one computer-readable storage medium, the computer-readable storage medium comprising a set of instructions, which, when executed by one or more processors, cause an apparatus at least to perform:
facilitate receiving of a preference information associated with a media content, the media content comprising a set of frames;
assign a score to at least one frame of the set of frames by at least one filter, the score being assigned based on the preference information and a weight associated with the at least one filter; and
determine a rank of the at least one frame based on the score.

52. The computer program as claimed in claim 51, wherein the preference information comprises a plurality of preference attributes and a weight associated with the plurality of preference attributes.

53. The computer program as claimed in claim 52, wherein the weight associated with the plurality of preference attributes is user-defined.

54. The computer program as claimed in claim 51, wherein the at least one frame comprises a media frame retrieved from a raw video stream.

55. The computer program as claimed in claim 51, wherein the apparatus is further caused, at least in part, to perform:
present the at least one frame based on the rank; and
present the at least one frame by facilitating displaying the at least one frame based on the rank.
